(19) United States
(12) Patent Application Publication
(10) Pub. No.: US 2025/0007957 A1
(43) Pub. Date: Jan. 2, 2025

(54) TRANSPARENCY OF INFORMATION COLLECTED FROM TENANT CONTAINER

(71) Applicant: Telefonaktiebolaget LM Ericsson (publ), Stockholm (SE)

(72) Inventors: Henrik NORMANN, Malmö (SE); Lina PÅLSSON, Genarp (SE); Bernard SMEETS, Dalby (SE); Mikael ERIKSSON, Alingsås (SE)

(21) Appl. No.: 18/696,635

(22) PCT Filed: Oct. 1, 2021
(86) PCT No.: PCT/EP2021/077060

§ 371 Date: Mar. 28, 2024

(51) Int. Cl. H04L 9/40

(52) U.S. Cl. CPC H04L 63/20

(57) ABSTRACT

Embodiments of the present disclosure provide a method, a computing device and a computer program product for achieving transparency of information collected from a tenant container. The method is performed by the computing device. The method includes identifying collection of information from the tenant container by an endpoint agent resident on the computing device during execution of the tenant container and extracting a summary of collected information. Further, the method includes signing the extracted information using a signing key. The signing key is not accessible to one or more processes that are being executed on the computing device. Corresponding computing device and computer program products are also disclosed.

### TECHNICAL FIELD

The present disclosure relates generally to the field of cloud security systems. More particularly, it relates to method, computing device and computer program products for achieving transparency of information collected from a tenant container.

### BACKGROUND

Various mechanisms for providing virtualized computing resources are evolving. For instance, container technologies and corresponding container clustering platforms are emerging as a solution for implementing flexible and scalable application virtualization mechanisms. In such mechanisms, an application may be implemented using a set of containers, for example, with different functions that are provisioned on a set of computing resources, where the computing resources can be physical computing resources or virtual computing resources such as virtualized in a data center or multiple data centers or container clustering platforms.

Usage of containers is a method of virtualization of computers or, more specifically, computer software applications. A container separates the application from the operating system and physical infrastructure it uses to connect to the computing network. The use of containers, for example, Docker, is known for rapid provisioning within clusters and cloud environments. Docker is an open platform container for developers and system administrators to build and run distributed applications.

Typically, a container refers to a software package that may be executed in a computing device. The container may be provided as a service which is commonly referred to container as a service, CaaS, in which an organization providing runtime and resources for another organization to deploy their container(s) in a public cloud. The organization hosting the containers may be known as a cloud service provider, CSP and the organization that provides the container to the CSP is typically referred to as a tenant. Further, the organization providing the container to a tenant is typically referred as a vendor of the container.

As illustrated in FIG. 1, the CSP may allow the container belonging to the tenant, i.e., a tenant container 25 to be hosted and executed in any computing device or an electronic device such as a first computing device 102. The tenant container 25 is instantiated within kernel 20 of operating system, and the tenant container 25 virtualizes the instance of an application. The tenant container 25 does not include the operating system like a virtual machine. The use of containers enable running multiple applications using same computer resources of the first computing device 102, without the applications interfering each other. Typically, the tenant container 25 doesn't have an externally available IP address of its own, although it has a unique ID that may be used by the CSP that hosts the tenant container 25. A server or the CSP manages the tenant container, and the tenant container 25 manages the application code.

The tenant has no control or ownership of the underlying hardware 15 including a central processing unit, CPU 10, memory 12 and devices 14. An endpoint agent 40, which may for example be an endpoint detection and response, enables the CSP to have control over the tenant container 25 it is hosting. The endpoint agent 40 may detect when the tenant container 25 shows suspicious behavior and also collects the information related to the execution when a security alert occurs. The collected information by the endpoint agent 40 residing in the first computing device 102 is then transmitted to an endpoint agent 40 in the second computing device 40 i.e., a server, which may be later used for analysing the collected information to detect a cyber-threat. In some instances, the collected information by the endpoint agent 40 may be used for forensics. Therefore, the CSP can register potential container breakouts and other unwanted behavior and also to determine the root cause of the suspicious behavior. Further, the endpoint agent 40 also enables the CSP to easily collect an unlimited amount of information from the tenant container 25.

Thus, the CSP can host and run many tenant containers producing a lot of valuable information. Some of the information the tenant containers produce are metadata and general logging while other information within the tenant container may be sensitive.

### SUMMARY

In general, a tenant has a service level agreement with cloud service provider, CSP, but how the tenant can be assured that the CSP is fulfilling the agreement may be hard for the tenant to verify. The tenant can trust the CSP as an organization. However, it may in some instances happen that a rogue insider within the organization may breach the service level agreement. It is also possible that, during setup of the container environment it can be made in a secure manner potentially under direct supervision by the tenant. However, during normal operation, the tenant may not constantly supervise the operating environment and the risk for a rogue insider increases and remains a constant threat. Some of the information the tenant containers produce are metadata and general logging while other information within the tenant container may be sensitive.

Consequently, there is a need for an improved method and arrangement for securing a tenant container that alleviates at least some of the above cited problems.

It is therefore an object of the present disclosure to provide a method, a computing device, and a computer program product for securing information related to the tenant container to mitigate, alleviate, or eliminate all or at least some of the above-discussed drawbacks of presently known solutions.

This and other objects are achieved by means of a method, a computing device, and a computer program product as defined in the appended claims. The term exemplary is in the present context to be understood as serving as an instance, example or illustration.

According to a first aspect of the present disclosure, a method for securing a tenant container executed by a computing device is provided. The method is performed by the computing device. The method comprises identifying collection of information from the tenant container by an endpoint agent resident on the computing device during execution of the tenant container and extracting a summary of collected information. Further, the method comprises signing the extracted information using a signing key. The signing key is not accessible to one or more processes that are being executed on the computing device and at least some of the information collected from the tenant container by the endpoint agent is accessible for extraction of summary of the collected information.

In some embodiments, the method further comprising transmitting the signed information to one or more of: a tenant associated with the tenant container and a vendor associated with the container.

In some embodiments, the step of identifying the collected information related to the tenant container further comprises determining one or more rules applied by the endpoint agent for collecting the information from the tenant container during execution of the tenant container.

In some embodiments, the method further comprising receiving a request for inspecting of the summary from a tenant or vendor of the container and transmitting the summary of the collected information to the tenant or the vendor of the container. Further, the method comprising receiving an indication related to verification of the authenticity of the summary from the tenant or the vendor of the container.

In some embodiments, wherein the information from the tenant container comprises metadata, events, and alerts related to multiple software processes, relationships between the software processes, operation of the first computing device, private data, Personal Identifiable Information, PII, operation of the computing device, and operating system configuration changes.

According to a second aspect of the present disclosure, a computing device for securing a tenant container is provided. The computing device being adapted for identifying collection of information from the tenant container by an endpoint agent resident on the computing device during execution of the tenant container and extracting a summary of collected information. Further, the computing device being adapted for signing the extracted information using a signing key. The signing key is not accessible to one or more processes that are being executed on the computing device and at least some of the information collected from the tenant container by the endpoint agent is accessible for the extraction of summary of the collected information.

According to a third aspect of the present disclosure, there is provided a computer program product comprising a non-transitory computer readable medium, having thereon a computer program comprising program instructions. The computer program is loadable into a data processing unit and configured to cause execution of the method according to the first aspect when the computer program is run by the data processing unit.

According to a fourth aspect of the present disclosure, there is provided a computer program comprising instructions which, when the computer program is executed by a computer, cause the computer to carry out the method according to the first aspect.

An advantage of some embodiments is that alternative and/or improved approaches are provided for securing collection of information of the tenant container.

An advantage of some embodiments is that transparency may be provided for a tenant and a vendor of the container for verifying how much information related to the container is collected by an endpoint agent or any other threat detection system. Thus, in contrast to the existing solutions, where the tenant has to trust the cloud service provider, CSP, to comply with the service level agreement without any possibility of insight on what information is collected from their containers and the container vendor has no way to identify what information is collected from the containers during the execution of the containers.

An advantage of some embodiments is that, the tenant may identify that information has been collected from the container. For example, the tenant, by evaluating the summary of the data collected by the endpoint agent, may determine that particular information related to the container is extracted by the endpoint agent used by the CSP, which may be used for identifying that the CSP is responsible for collection of the information from the container.

An advantage of some embodiments is that the vendor may receive an indication from the summary of the data collected by the endpoint agent on whether or not there are attempts to extract valuable information from the container by malicious actors within the CSP or the tenant.

An advantage of some embodiments is that the tenant or a container executor may be able to present a trustworthy and registered summary of what information is collected from the container using the CSP's endpoint agent or the threat detection system.

An advantage of some embodiments is that tenant or the container vendor may determine what information from the tenant container is extracted and/or rules applied for collecting the information from the tenant container.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 discloses an existing implementation of a cloud service provider hosting a tenant container;

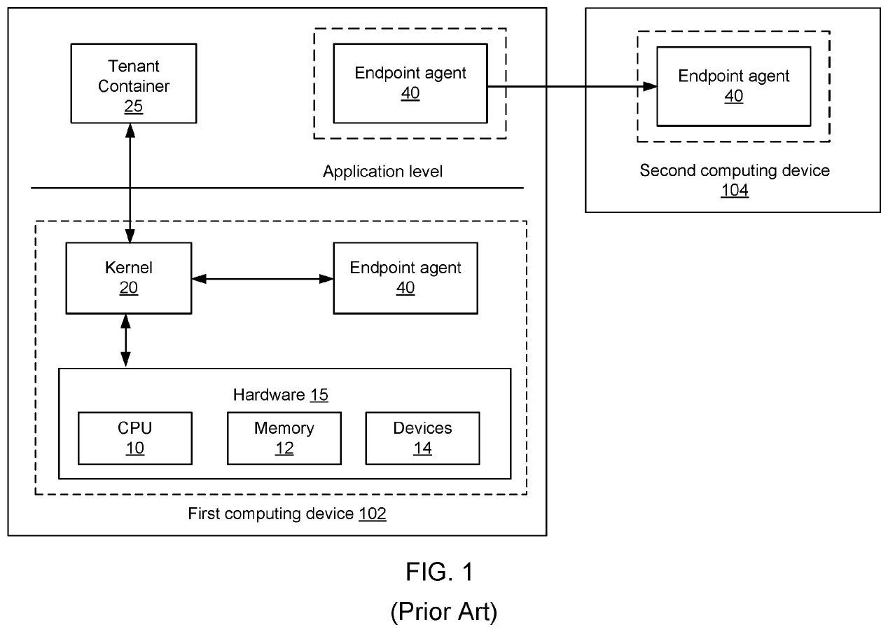

FIG. 2 discloses block diagram illustrating computing devices connected to a network;

FIG. 3 is a flowchart illustrating example method steps of a method performed by a computing device for securing information related to a tenant container;

FIG. 4 discloses an example implementation for securing the information related to the tenant container;

FIG. 5 is an example schematic diagram showing functional modules of an endpoint agent according to some embodiments; and

FIG. 6 discloses an example computing environment.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

In the following description of exemplary embodiments, the same reference numerals denote the same or similar components.

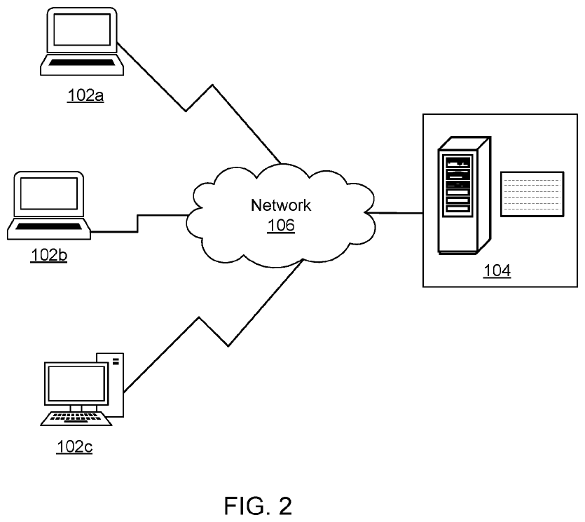

FIG. 2 discloses block diagram illustrating computing devices connected to a network. As depicted in FIG. 2, there may be a plurality of first computing devices 102a, 102b and 102c, (which may be collectively referred as 102) connected a network 106. The network 106, for example, may be an informational technology network, an operational technology network, a cloud infrastructure, a software as a service, SaaS, infrastructure or any combination of these four, connected to each of the first computing devices 102a, 102b and 102c. A second computing device 104 may be a server or any electronic device that receives information related to a tenant container from an endpoint agent (not shown) which is resident on each of the first computing devices 102a, 102b and 102b for analysis of the information, for example, to detect any suspicious behaviour.

Each of the first computing device 102a, 102b and 102c may include one or more tenant containers hosted by a cloud service provider, CSP and an endpoint agent, for example an endpoint detection and response unit. Each of the first computing devices 102a, 102b and 102c execute the tenant containers. Further, the endpoint agents may be configured to monitor and collect the information from the tenant container being executed on the first computing devices 102a, 102b and 102c.

The endpoint agents that are resident on the first computing devices 102a, 102b and 102c enable the CSP, to have control over the tenant containers which are hosted by the CSP.

The endpoint agent may detect when the tenant container 25 shows suspicious behavior and also collect the information related to the execution when a security alert occurs. The collected information by the endpoint agent residing in the first computing device 102a is then transmitted to an endpoint agent in the second computing device 104 i.e., a server, which may be later used for analysing the collected information to detect a cyber-threat.

Therefore, the CSP can register potential container breakouts and other unwanted behavior and also to determine the root cause of the suspicious behavior. Further, the endpoint agent on the first computing device 102a also enables the CSP to easily collect an unlimited amount of information from the tenant container. Some of the information the tenant containers produce are metadata and general logging while other information within the tenant container may be sensitive.

Therefore, according to some embodiments of the present disclosure, the first computing device 102a implements a method for efficiently securing the information related to the tenant container executed in the first computing device 102a. It should be noted that any of the first computing devices 102a, 102b and 102c, hereinafter referred to as 102, may implement the method for securing the information related to the tenant container.

According to some embodiments, the first computing device 102 may be adapted for identifying collection of information from the tenant container by an endpoint agent resident on the first computing device 102 during execution of the tenant container. In some examples, the information related to the tenant container or the information from the tenant container may include metadata, events, and alerts related to multiple software processes, relationships between the software processes, operation of the first computing device, private data, Personal Identifiable Information, PII, related to the tenant container, and operating system configuration changes. The first computing device 102 is adapted for extracting a summary of collected information by the endpoint agent. For example, the summary collected information by the endpoint agent is extracted in association with corresponding time stamps related to the collection of the information. Further, the first computing device 102 is adapted for signing the extracted information using a signing key or a private key.

In some examples, the first computing device 102 is adapted for transmitting the signed information to a second computing device 104. In some examples, the signed information may be stored on the first computing device or the signed information may be published through a webserver on the first computing device 102. In some examples, the signed information may be exported to a universal serial bus, USB device or the like.

Thus, the tenant may receive the signed information related to the tenant container and the tenant may verify the signed information using a public key. Therefore, the tenant or the vendor may identify the information of the tenant container that is extracted by the CSP.

Various embodiments for securing the information related to the tenant container are explained in conjunction with figures in the later parts of the description.

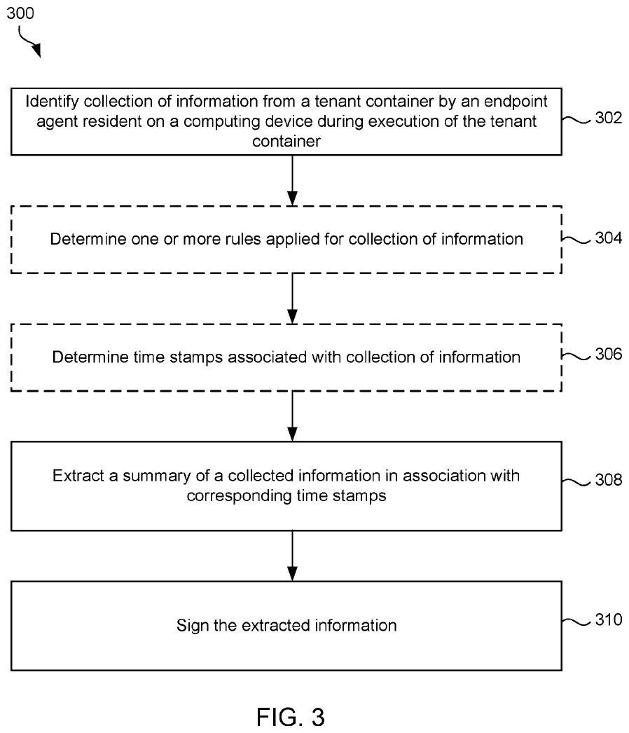

FIG. 3 is a flowchart illustrating example method steps of a method 300 performed by the first computing device for securing the information related to the tenant container. As stated above, the first computing device performs the method 300 for securing the tenant container executed. For example, the information related to the tenant container may include but not limited to data that includes metadata, events, and alerts regarding at least the users, multiple software processes, relationships between the software processes, operation of the first computing device, private data, Personal Identifiable Information, PII, operating system configuration changes, and combinations of these parameters. At step 302, the method 300 comprises identifying collection of information from the tenant container by an endpoint agent resident on the computing device during execution of the tenant container. The tenant container is hosted by the CSP in the first computing device and the first computing device executes the tenant container. When the tenant container is being executed by the first computing device, the endpoint agent resident on the first computing device may be configured to collect the information related to the tenant container. The endpoint agent may be for example, an endpoint detection and response unit configured to monitor and collect information from the tenant container executing on the first computing-device. In some examples, the endpoint agent may belong to the CSP that has hosted the tenant container in the first computing device. The information collected from the tenant container by the endpoint agent is identified. For example, an information identification module is implemented in the first computing device to identify the information that is collected by the endpoint agent resident on the first computing device. The information identification module is configured such that it interacts with the endpoint agent which is accessible to extract the summary of the collected information or to receive the collected information from the endpoint agent.

It should also be noted that all, or a subset of, the information collected by the endpoint agent should be accessible by the information identification module.

In some examples, the endpoint agent may belong to the tenant. In such case, the CSP may implement the endpoint agent of the tenant, as requested by the tenant, to collect the information from the tenant container since the outcome of endpoint agent can be in the interest of the tenant to supervise the behavior of the tenant container.

At step 308, the method 300 comprises extracting a summary of the collected information. For example, the summary of the collected information can include how the information from the tenant container is collected, for example, the summary can include the collected information, analysis of the output, for instance which or how many invocations are made, or any combination of the mentioned. In some examples, the summary of the collected information can include time stamps of the collected information, i.e., a time stamped summary of the information collected from the tenant container.

In some examples, the one or more rules applied by endpoint agent for collection of the information from the tenant container is determined as illustrated by the optional step 304. For example, the information identification module on the first computing device may be configured to determine the one or more rules applied by the endpoint agent for collecting the information from the tenant container during execution of the tenant container or a summary, for instance a digest, of the same.

Further, the method 300 comprises determining the time stamps associated with the collection of the information from the tenant container as illustrated by the optional step 306. For example, the time stamps defining the time instances of collection of information from the tenant container is determined. The information identification module on the first computing device may be configured to determine the time stamps associated with the collection of the information from the tenant container.

At step 310, the method 300 comprises signing the extracted summary of the information. The first computing device signs the extracted summary of information, for example by using the private part of an asymmetric key, referred to as the signing key or the stamp key. The stamp key is securely created in, or securely imported to, a trusted platform inside the first computing device. It should be noted that the private part of the stamp key is accessible only at a known boot-process, including a known setup of kernel, kernel modules and the information identification module. In some example implementations, the information identification module can be implemented in a secure environment or a trusted execution environment, TEE, which is entrusted with the stamp key during an initialization phase. It should further be noted that the access to the signing key is not accessible to one or more processes that are being executed on the first computing device, other than the information identification module as described above. The information identification module may have the exclusive right to access the signing key, ensuring no other process executed on the first computing device can access the signing key.

In some embodiments, the method 300 includes transmitting the signed information to a tenant associated with the tenant container and a vendor associated with the container. For example, the first computing device receives a request from the tenant or the vendor of the container for inspecting of the summary of the collected information from the tenant container. Upon receiving the request from the tenant or the vendor of the container for inspecting of the summary of the collected information, the first computing device transmits the summary of the collected information to the tenant or the vendor of the container.

The tenant may receive the signed information related to the tenant container and the tenant may verify the signed information using the public part of the stamp key. Therefore, the tenant or the vendor may identify the information of the tenant container that is extracted by the CSP. Further, the first computing device receives an indication related to verification of the authenticity of the summary from the tenant or the vendor of the container.

In some examples, the signed summary of the extracted information is updated periodically, for instance at every minute or every hour or additionally when an alert is generated by the endpoint agent or the threat detection system. To prevent that parts of the summary is removed, the complete summary can be hashed together using the private part of the stamp key. Alternatively, a chain of hashes can be used so that every hash generated based on the previous hash.

It should be noted that the information identification module is connected to the endpoint agent so that at least some of the information, all the information, or a subset of the information that is collected by the endpoint agent is registered by the information identification module. It should also be noted that the extracted summary of the collected information cannot be manipulated which means that the signed summary of the extracted information is trustable.

In some examples, the signed information may be stored on the first computing device or the signed information may be published through a webserver on the first computing device 102. In some examples, the signed information may be exported to a USB device or the like.

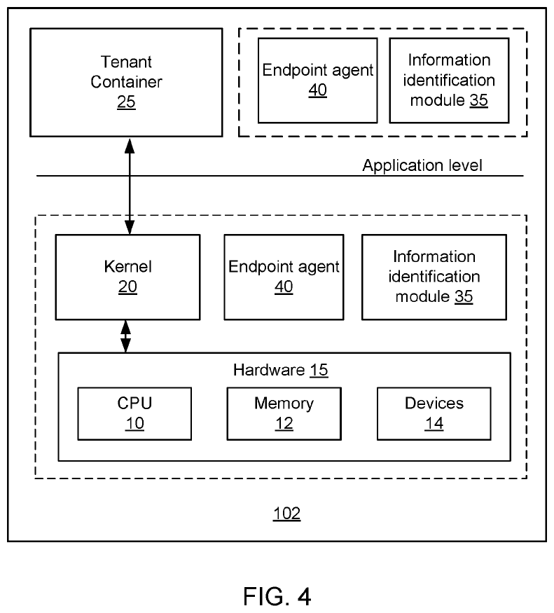

FIG. 4 discloses an example implementation for securing the information related to the tenant container. As depicted in FIG. 4, the computing device 102 (for example, a first computing device 102 as shown in FIG. 2) may include a tenant container 25, an endpoint agent 40 and an information identification module 35.

It should be noted that the endpoint agent 40 and the information identification module 35 may be implemented at an application level within the first computing device 102 or in some implementations the endpoint agent 40 and the information identification module 35 may be instantiated in a kernel 20 as shown in the FIG. 4.

It should be noted that the information identification module 35 can access at least some of the information, all the information, or a subset of the information, collected from the tenant container by the endpoint agent 40.

The computing device 102 may obtain a stamp key which can be generated or created securely inside the information identification module 35, for instance by using a trusted platform or by population of secure environment or a trusted execution environment. The public part of the stamp key may be certified and provided to the tenant or the vendor of the tenant container and access of the private part of the stamp key can be limited so that it is only accessible by the information identification module 35.

In some examples, the stamp key may be obtained from the secure environment in response to the request transmitted to the secure environment. The private key may be used by the computing device 102 for signing the extracted summary of the information related to the tenant container 25.

The endpoint agent 40 that is resident on the first computing device 104 may be configured for collecting the information related to the tenant container during execution of the tenant container.

In some embodiments, the information identification module 35 may be configured for identifying the collection of information from the tenant container by the endpoint agent 40 during execution of the tenant container and extracting a summary of collected information. For example, the summary of the collected information can include how the information from the tenant container is collected, for example It can include a digest of the collected information, analysis of the output, for instance which or how many invocations are made, or any combination of the mentioned. In some examples, the summary of the collected information can include time stamps of the collected information, i.e., a time stamped summary of the information collected from the tenant container.

In some examples, the one or more rules applied by endpoint agent 40 for collection of the information from the tenant container is determined by the information identification module 35.

Further, the information identification module 35 may be configured for signing the extracted information using the private part of the stamp key created in, or obtained from, the secure environment hosted in the computing device 102.

It should be noted that information identification module is connected to the endpoint agent so that at least some of the information, all the information, or a subset of the information that is collected by the endpoint agent is registered by the information identification module. It should also be noted that the extracted summary of the collected information cannot be manipulated which means that the signed summary of the extracted information is trustable.

In some embodiments, the information identification module 35 is adapted for transmitting the signed information to the tenant and the vendor associated with the container. For example, the computing device 102 receives a request from the tenant or the vendor of the container for inspecting of the summary of the collected information from the tenant container. Upon receiving the request from the tenant or the vendor of the container for inspecting of the summary of the collected information, the first computing device transmits the summary of the collected information to the tenant or the vendor of the container.

The tenant may receive the signed information related to the tenant container and the tenant may verify the signed information using the public part of the signing key or the stamp key. Therefore, the tenant or the vendor may identify the information of the tenant container that is extracted by the CSP and the computing device 102 receives an indication related to verification of the authenticity of the summary of the collected information from the tenant or the vendor of the container.

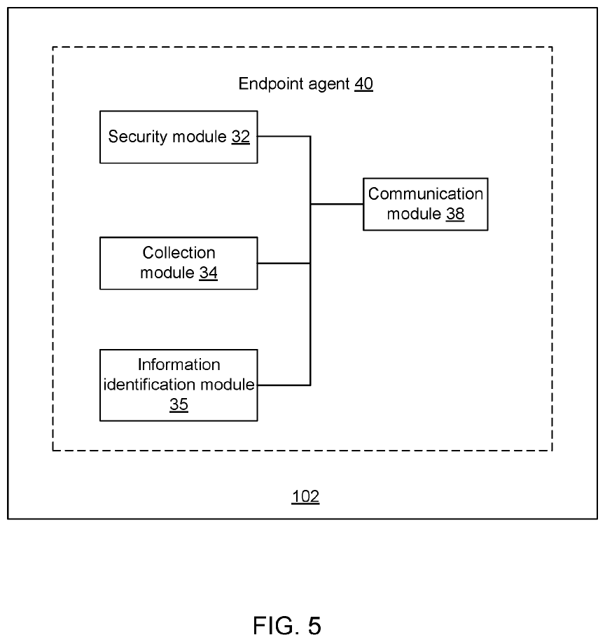

FIG. 5 is an example schematic diagram showing functional modules of an endpoint agent according to some embodiments. As depicted in the FIG. 5, the endpoint agent 40 on the computing device 102 may include one or more modules configured to cooperate with each other for securing the information related to the tenant container. For example, the endpoint agent 40 may include a security module 32, a collection module 34, the information identification module 35 and a communication module 36.

The security module 32 may be configured for registering for an encryption service executing within the secure environment hosted in the computing device 102. The security module 32 may be configured for generating a request for the encryption service and transmitting the request for the encryption service to the secure environment. Further, the security module 32 may obtain a stamp key, which includes a private key and a public key, from the secure environment in response to the request transmitted to the secure environment. Furthermore, the security module may transmit the private key to the information identification module 35 for signing the information from the tenant container, or the signing can be performed inside of the security module, e.g. in case of the security module consisting of the information identification module 35.

In some examples, the security module 32 is configured for transmitting the public part of the signing key to the tenant or the vendor associated with the tenant container so that the tenant or the vendor associated with the tenant container can verify the authenticity of the summary from the tenant or the vendor of the container.

The collection module 34 in the endpoint agent 40 may monitor and collect the information related to the tenant container, which may include data of multiple software processes executing on the computing device 102 and one or more users of the computing device 102.

The collection module 34 may collect the information related to the tenant container that may include metadata, events, and alerts regarding at least the users, multiple software processes, relationships between the software processes executing on the first computing device, operation of the first computing device, private data, Personal Identifiable Information, PII, and operating system configuration changes.

The information identification module 35 may be configured to identify the collection of information by the collection module 34 and the information identification module 35 may be configured for extracting the summary of the collected information from the tenant container, from the collection module 34. The access between the endpoint agent and the information identification module should be configured so that at least some of the information, all the information related to tenant collected by the endpoint agent should be accessible by the information identification module.

Further, the information identification module 35 may be configured for signing the extracted information using the private key created or obtained from the secure environment hosted in the computing device 102. In some examples, the signing is instead performed inside of the security module, e.g. in case of the security module consisting of a information identification module 35. In some examples, the information identification module 35 may be configured for transmitting the signed information to the tenant and the vendor associated with the container.

The communication module 36 may be configured for periodically transmitting the signed summary of the information related to the tenant container to the second computing device installed on the network connected to the computing device 102. In some examples, communication module 36 may be configured for exporting the signed summary of the information to a USB device or the like or publishing the result as a web server.

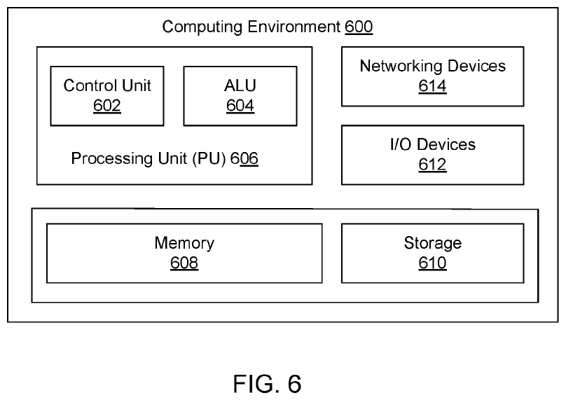

FIG. 6 illustrates an example computing environment 900 implementing a method and the first computing device and the second computing device for securing the information related to the tenant container as described in FIG. 3. As depicted in FIG. 9, the computing environment 600 comprises at least one processing unit 606 which is a data processing unit, that is equipped with a control unit 602 and an Arithmetic Logic Unit, ALU 604, a memory 608, a storage 610, plurality of networking devices 614 and a plurality Input output, I/O devices 612. The data processing unit 606 is responsible for processing the instructions of the algorithm. For example, the data processing unit 906 is equivalent to the processor of the network node. The processing unit 606 is capable of executing software instructions stored in memory 608. The processing unit 606 receives commands from the control unit 602 in order to perform its processing. Further, any logical and arithmetic operations involved in the execution of the instructions are computed with the help of the ALU 604.

The computer program is loadable into the data processing unit 606, which may, for example, be comprised in an electronic apparatus. When loaded into the processing unit 606, the computer program may be stored in the memory 608 associated with or comprised in the data processor. According to some embodiments, the computer program may, when loaded into and run by the data processing unit 606, cause execution of method steps according to, for example, any of the methods illustrated in FIG. 3 or otherwise described herein

The overall computing environment 600 may be composed of multiple homogeneous and/or heterogeneous cores, multiple CPUs of different kinds, special media and other accelerators. The processing unit 606 is responsible for processing the instructions of the algorithm. Further, the plurality of processing units 606 may be located on a single chip or over multiple chips.

The algorithm comprising of instructions and codes required for the implementation are stored in either the memory 608 or the storage 610 or both. At the time of execution, the instructions may be fetched from the corresponding memory 608 and/or storage 610, and executed by the processing unit 606.

In case of any hardware implementations various networking devices 614 or external I/O devices 612 may be connected to the computing environment to support the implementation through the networking devices 614 and the I/O devices 612.

The embodiments disclosed herein can be implemented through at least one software program running on at least one hardware device and performing network management functions to control the elements. The elements shown in FIG. 6 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

1. A method for securing a tenant container executed by a computing device, the method performed by the computing device, the method comprising:
identifying collection of information from the tenant container by an endpoint agent resident on the computing device during execution of the tenant container;
extracting a summary of collected information; and
signing the extracted summary of the information with a signing key,
wherein the signing key is not accessible to one or more processes that are being executed on the computing device,
wherein at least some of the information collected from the tenant container by the endpoint agent is accessible for extraction of summary of the collected information.

2. The method according to claim 1, further comprising:
transmitting the signed information to one or more of: a tenant associated with the tenant container and a vendor associated with the container.

3. The method according to claim 1, wherein the step of identifying the collection of information related to the tenant container further comprises:
determining one or more rules applied by the endpoint agent for collecting the information from the tenant container during execution of the tenant container.

4. The method according to claim 1, wherein the method further comprising:
receiving a request for inspecting of the summary from a tenant or vendor of the container;
transmitting the summary of the collected information to the tenant or the vendor of the container; and
receiving an indication related to verification of the authenticity of the summary from the tenant or the vendor of the container.

5. The method according to claim 1, wherein the information from the tenant container comprises at least one of metadata, events, and alerts related to multiple software processes, relationships between the software processes, private data, Personal Identifiable Information, PII, operation of the computing device, and operating system configuration changes.

6. A computing device for securing a tenant container, the computing comprising:
processing circuitry;
at least one memory connected to the processing circuitry and storing program code that is executed by the processing circuitry to perform operations comprising
identify collection of information from the tenant container by an endpoint agent resident on the computing device during execution of the tenant container;
extract a summary of collected information; and
sign the extracted information using a signing key,
wherein the signing key is not accessible to one or more processes that are being executed on the computing device,
wherein at least some of the information collected from the tenant container by the endpoint agent is accessible for extraction of summary of the collected information.

7. The computing device according to claim 6, wherein the at least one memory is connected to the processing circuitry and stores program code that is executed by the processing circuitry to perform further operations comprising:
transmit the signed information to one or more of: a tenant associated with the tenant container and a vendor associated with the container.

8. The computing device according to claim 6, wherein the at least one memory is connected to the processing circuitry and stores program code that is executed by the processing circuitry for identify the collected information related to the tenant container by:
determining one or more rules applied by the endpoint agent for collecting the information from the tenant container during execution of the tenant container.

9. The computing device according to claim 6, wherein the at least one memory is connected to the processing circuitry and stores program code that is executed by the processing circuitry to perform further operations comprising:
receive a request for inspecting of the summary from a tenant or vendor of the container; and
transmit the summary of the collected information to the tenant or the vendor of the container; and
receive an indication related to verification the authenticity of the summary from the tenant or the vendor of the container.

10. The computing device according to claim 6, wherein the information from the tenant container comprises at least one of metadata, events, and alerts related to multiple software processes, relationships between the software processes, private data, Personal Identifiable Information, PII, operation of the computing device, and operating system configuration changes.

11. A computer program product comprising a non-transitory computer readable medium including program code to be executed by processing circuitry of a computing device, whereby execution of the program code causes the computing device to perform operations comprising:
identify collection of information from the tenant container by an endpoint agent resident on the computing device during execution of the tenant container;
extracting a summary of collected information; and
signing the extracted summary of the information with a signing key,
wherein the signing key is not accessible to one or more processes that are being executed on the computing device,
wherein at least some of the information collected from the tenant container by the endpoint agent is accessible for extraction of summary of the collected information.

12. (canceled)

13. The computer program product of claim 11, whereby execution of the program code causes the computing device to perform further operations comprising:
transmit the signed information to one or more of: a tenant associated with the tenant container and a vendor associated with the container.

14. The computer program product of claim 11, wherein identify the collection of information related to the tenant container further comprises:
determine one or more rules applied by the endpoint agent for collecting the information from the tenant container during execution of the tenant container.

15. The computer program product of claim 11, whereby execution of the program code causes the computing device to perform further operations comprising: receiving a request for inspecting of the summary from a tenant or vendor of the container;
transmit the summary of the collected information to the tenant or the vendor of the container; and
receive an indication related to verification of the authenticity of the summary from the tenant or the vendor of the container.

16. The computer program product of claim 11, wherein the information from the tenant container comprises at least one of metadata, events, and alerts related to multiple software processes, relationships between the software processes, private data, Personal Identifiable Information, PII, operation of the computing device, and operating system configuration changes.
